(19) United States
(12) Patent Application Publication
(10) Pub. No.: US 2017/0224158 A1
(43) Pub. Date: Aug. 10, 2017

(54) CHARCOAL GRILL APPARATUS

(71) Applicant: Zippy Labs, LLC, Austin, TX (US)

(72) Inventors: Jonathan K. Ho, Austin, TX (US); Eric Tsang, Anaheim, CA (US)

(73) Assignee: Zippy Labs, LLC, Austin, TX (US)

(21) Appl. No.: 15/194,057

(22) Filed: Jun. 27, 2016

Related U.S. Application Data
(60) Provisional application No. 62/292,977, filed on Feb. 9, 2016.

(51) Int. Cl. A47J 37/07

(52) U.S. Cl. CPC A47J 37/0704; A47J 2037/0777

(57) ABSTRACT

Embodiments provide a charcoal grill apparatus.

### CROSS-REFERENCE TO RELATED APPLICATIONS

This Nonprovisional patent application claims priority to Provisional Patent Application No. 62/292,977, filed Feb. 9, 2016, which is hereby incorporated by reference in its entirety.

### FIELD OF THE INVENTION

The present disclosure relates to a charcoal grill apparatus, and more specifically to a fast-starting and portable charcoal grill apparatus.

### BACKGROUND OF THE INVENTION

Urban dwellers who wish to grill using charcoal often do not have the space to store and operate a full size charcoal grill. Smaller grills, while more portable, require additional accessories such as a chimney starter or ignition fluid to help with igniting the charcoal. Ignition fluid can negatively affect the taste of the food. Chimney starters, while chemical-free, can be almost as large as a compact grill itself rendering it inconvenient for a solo operator to transport both the grill and the chimney starter to and from the grilling site.

### BRIEF SUMMARY OF THE INVENTION

The disclosed charcoal grill apparatus may function both as a portable chimney starter and a grill. The apparatus may, in embodiments, combine the elements of a chimney starter and a grill in a compact form that is easy to handle pre and post grilling. In its “chimney configuration”, the operator may fill the device with charcoal and ignite kindling material in a portion of the device underneath the charcoal. This allows for the “chimney effect” that may produce a rapid ignition of the charcoal. After the charcoal is lit, the operator may configure the device into a “grill configuration” and may operate it as a grill. This may be accomplished by releasing and pulling down the hinged front sidewall until it is level with the charcoal grate, revealing additional surface area to spread the charcoal.

A food-grilling grate may then be affixed several inches above the charcoal surface. This two-in-one utility may eliminate the need for charcoal lighting accessories or chemicals beyond basic paper for kindling.

### BRIEF DESCRIPTION OF THE DRAWINGS

The novel features believed characteristic of the disclosed subject matter will be set forth in any claims that are filed. The disclosed subject matter itself, however, as well as further objectives, and advantages thereof, will best be understood by reference to the following detailed descriptions of illustrative embodiments when read in conjunction with the accompanying FIGURES, wherein:

FIG. 1 displays a front view of a charcoal grill in a “chimney configuration” in accordance with embodiments.

FIG. 2 displays a rear view of a charcoal grill in a “chimney configuration” in accordance with embodiments.

FIG. 3 displays a top view of a charcoal grill in accordance with embodiments.

FIG. 4 displays a front view of a charcoal grill in accordance with embodiments.

FIG. 5 displays a perspective view of a charcoal grill apparatus 5 including a rest positioned in an extended position in accordance with embodiments.

FIG. 6 displays a perspective view of a charcoal grill in a “grill configuration” in accordance with embodiments.

FIG. 7 displays a cooking grid affixed to a position above the charcoal platform in accordance with embodiments.

FIG. 8 displays a perspective view of a charcoal grill including a cooking grid in accordance with embodiments.

FIG. 9 displays a rest in a first position in accordance with embodiments.

FIG. 10 displays a rest in a second position in accordance with embodiments.

FIG. 11 displays an isometric view of a closed alternative embodiment of a charcoal grill apparatus including a cooking grid.

FIG. 12 displays a rear isometric view of a closed alternative embodiment of a charcoal grill apparatus including a cooking grid.

FIG. 13 displays an isometric view of an open alternative embodiment of a charcoal grill apparatus.

FIG. 14 displays a rear isometric view of an open alternative embodiment of a charcoal grill apparatus without a cooking grid.

FIG. 15 displays a side view of an open alternative embodiment of a charcoal grill apparatus.

FIG. 16 displays an isometric view of an alternative embodiment of a charcoal grill apparatus with an open top.

FIG. 17 displays a rear isometric view of an alternative embodiment of a charcoal grill apparatus with an open top.

FIG. 18 displays an isometric view of an alternative embodiment of a charcoal grill apparatus with an open top.

FIG. 19 displays a front isometric view of an alternative embodiment of a charcoal grill apparatus with an open top.

FIG. 20 displays an open isometric view of an alternative embodiment of a charcoal grill apparatus including a cooking grid.

FIG. 21 displays a rear open isometric view of an alternative embodiment of a charcoal grill apparatus including a cooking grid.

FIG. 22 displays an open isometric view of an alternative embodiment of a charcoal grill apparatus including a cooking grid.

FIG. 23 displays a rear open isometric view of an alternative embodiment of a charcoal grill apparatus including a cooking grid.

FIG. 24 displays an open isometric view of an alternative embodiment of a charcoal grill apparatus including a cooking grid.

FIG. 25 displays a rear open isometric view of an alternative embodiment of a charcoal grill apparatus including a cooking grid.

FIG. 26 displays a perspective view of an alternative embodiment of a charcoal grill including a cooking grid.

FIG. 27 displays a perspective view of an alternative embodiment of a charcoal grill including a cooking grid.

FIG. 28 displays a perspective front view of a charcoal grill apparatus in a “chimney configuration” in accordance with embodiments.

FIG. 29 displays a perspective rear view of a charcoal grill apparatus in a “chimney configuration” in accordance with embodiments.

FIG. 30 displays a perspective front view of a charcoal grill apparatus in an “open configuration” in accordance with embodiments.

### DETAILED DESCRIPTION OF ILLUSTRATIVE EMBODIMENTS

Reference now should be made to the FIGURES, in which the same reference numbers are used throughout the different FIGURES to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including,” when used in this specification, specify the presence of stated features, regions, integers, steps, operations, elements, and/or components, but do not preclude the presence or addition of one or more other features, regions, integers, steps, operations, elements, components, and/or groups thereof.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

In the following detailed description, reference is made to the accompanying FIGURES that form a part hereof, and in which is shown, by way of illustration, specific implementations which may be practiced. These implementations are described in sufficient detail to enable those skilled in the art to practice the implementations, and it is to be understood that other implementations may be utilized and that logical, mechanical, electrical, and other changes may be made without departing from the scope of the implementations. The following detailed description is, therefore, not to be taken in a limiting sense.

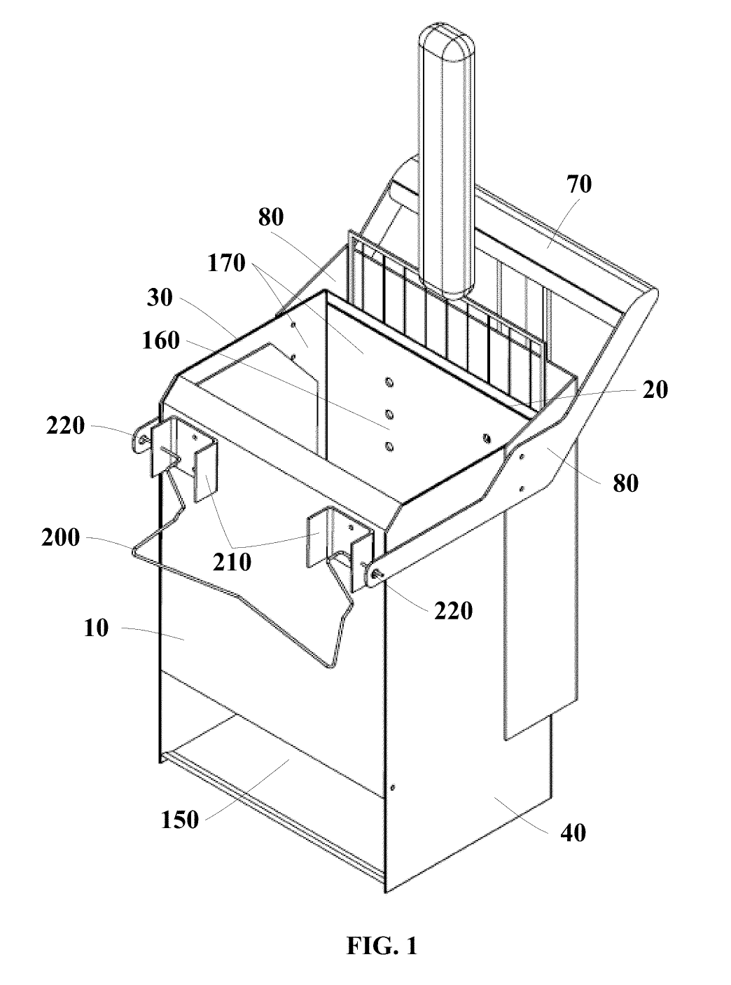

FIG. 1 displays a front view of a charcoal grill apparatus 5 in a “chimney configuration” in accordance with embodiments. “Chimney configuration” may refer to the fact that the grill 5 may be utilized as a chimney starter in this configuration. The apparatus 5 may comprise a front sidewall 10, rear sidewall 20, left sidewall 30, right sidewall 40, and bottom portion (not depicted). Flammable materials (not depicted), such as but not limited to, kindling paper, may be placed within a lower chamber 150 positioned below the front sidewall 10. In this embodiment, an opening of the lower chamber 150 may be open and may not include a door mechanism. In embodiments, the opening may be covered by a hinged bottom door (not depicted). When lit, the flammable materials may provide fire and heat to charcoal (not depicted) located in the upper chamber 160. Upper chamber sidewalls 170 may contain the charcoal within the upper chamber 160. A rest 200 may be affixed to the front sidewall 10 via a plurality of rest retainers 210. The configuration of the rest 200 may allow for the rest 200 to hinge from a retracted position to an extended position.

A handle 70 may be affixed to handle extensions 80 affixed to the left and right sidewalls 30,40. Rest orifices 220 may be positioned on ends of the handle extensions 80. In embodiments, portions of the rest 200 may be positioned within the rest orifices 220 when the rest 200 is in the retracted position. When the rest 200 is being reconfigured to an extended position, the portions of the rest 200 contained within the rest orifices 220 may be forced out of the rest orifices 220.

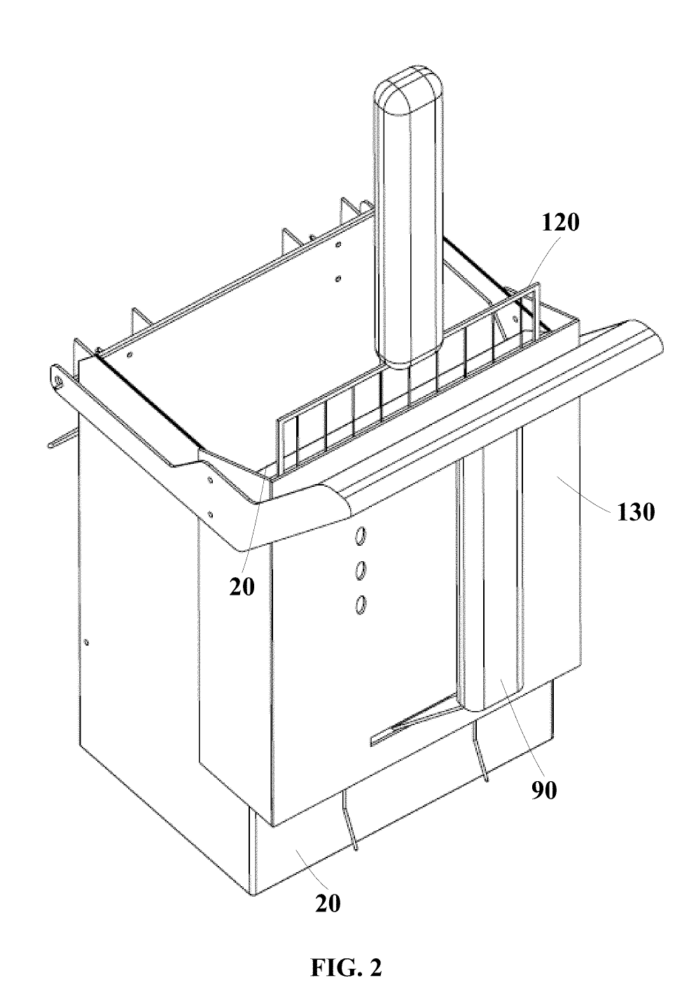

FIG. 2 displays a rear view of a charcoal grill apparatus 5 in a “chimney configuration” in accordance with embodiments. A cooking grid rack 130 may be affixed to the rear sidewall 20. When the cooking grid 120 is not being used, the cooking grid 120 may be stored in the cooking grid rack 130. A vertical handle 90 may be affixed to the cooking grid rack 130 in order to enable additional portability.

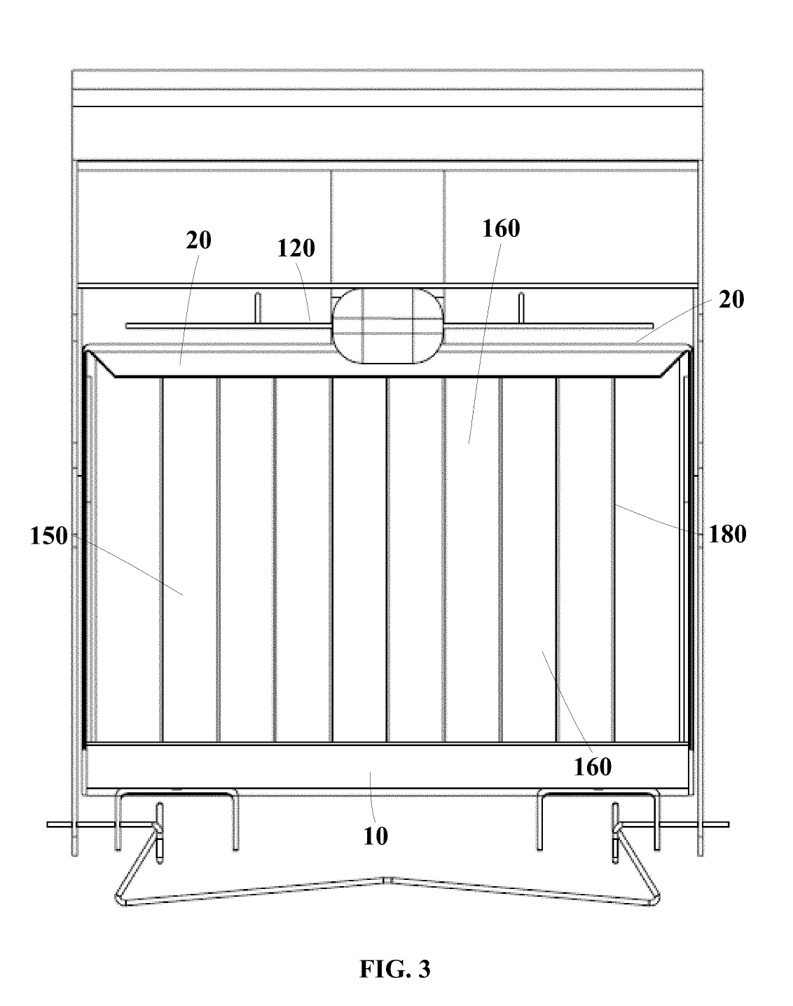

FIG. 3 displays a top view of a charcoal grill apparatus 5 in accordance with embodiments. A rock grate 180 may extend from the front sidewall 10 to the rear sidewall 20 and may define a barrier between the lower chamber 150 and the upper chamber 160. The rock grate 180 may additionally provide support to charcoal placed in the apparatus 5. In embodiments, the cooking grid rack 130 may not include a rack bottom portion (as shown). In embodiments, the cooking grid rack 130 may comprise a bottom portion (not depicted).

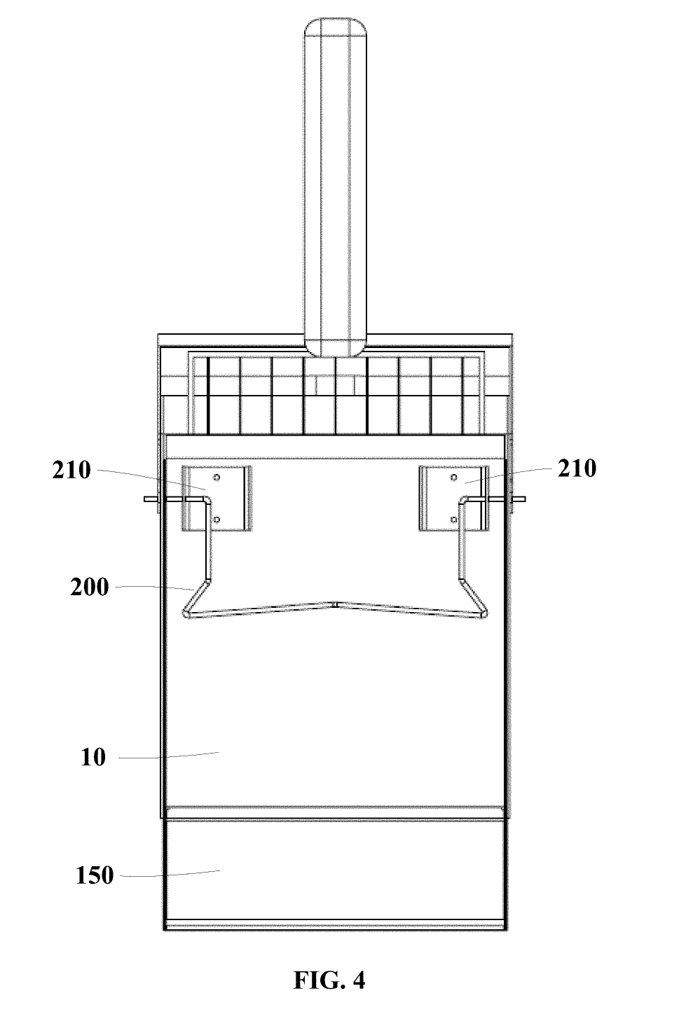

FIG. 4 displays a front view of a charcoal grill apparatus 5 in accordance with embodiments. The rest retainers 210 may be affixed to a top portion of the front sidewall 10. The lower chamber 150 may be positioned below the front sidewall 10. Portions of the rest 200 may protrude from the rest orifices 220 when the rest 200 is in a retracted position.

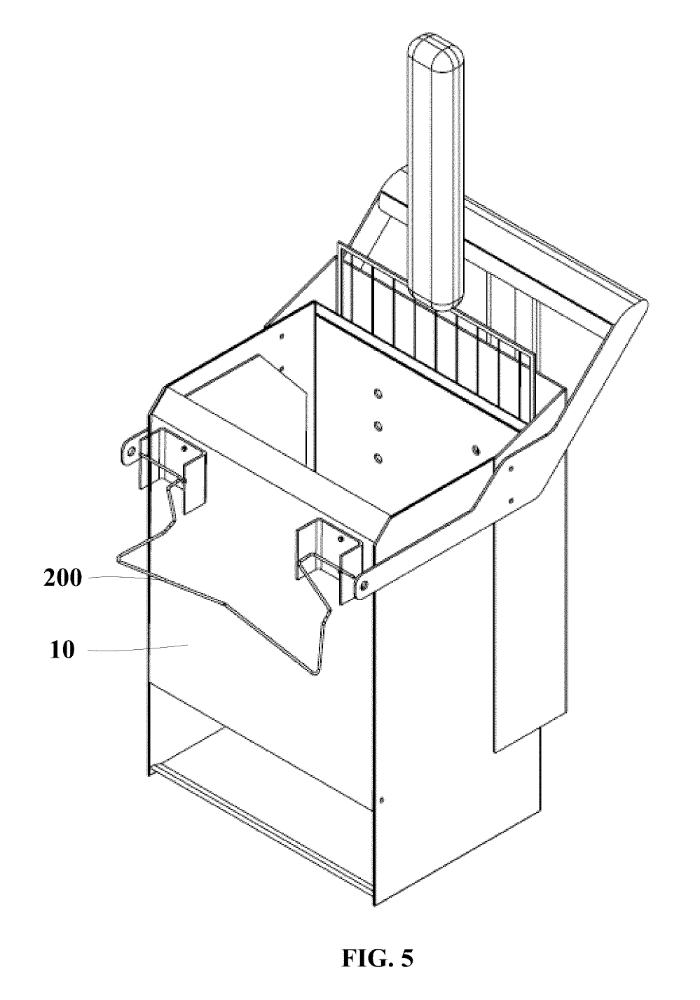

FIG. 5 displays a perspective view of a charcoal grill apparatus 5 including a rest 200 positioned in an extended position in accordance with embodiments. When the apparatus 5 is to be used as a grill, the rest 200 may be positioned in an extended position. When in the extended position, the rest 200 may be perpendicular to its position in the retracted configuration. The portions of the rest 200 that may be in the rest orifices 220 when the rest 200 is in a retracted position may not be in the rest orifices 220 when the rest 200 is in an extended position.

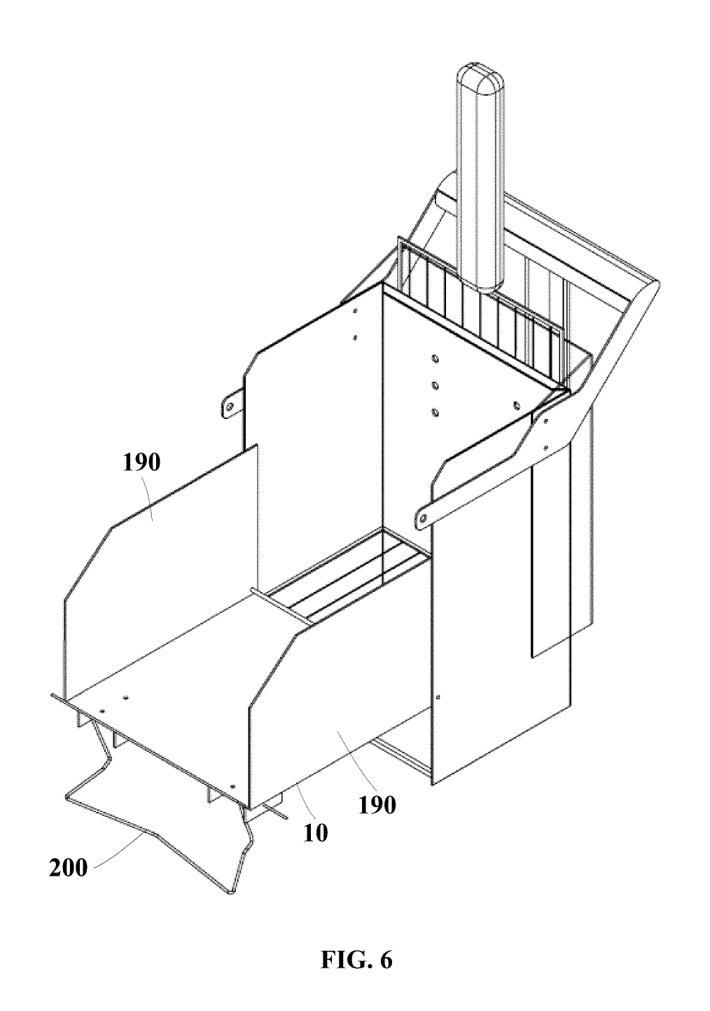

FIG. 6 displays a perspective view of the charcoal grill apparatus 5 in a “grill configuration” in accordance with embodiments. To convert the apparatus 5 from the “chimney configuration” to the “grill configuration”, the front sidewall 10 may be pulled downward once the rest 200 is in the extended position, thereby exposing the front sidewall interior walls 190. It is noted that the front sidewall 10 may be retractable and may be positioned in a closed configuration (FIG. 1) as well as an open configuration (FIG. 6).

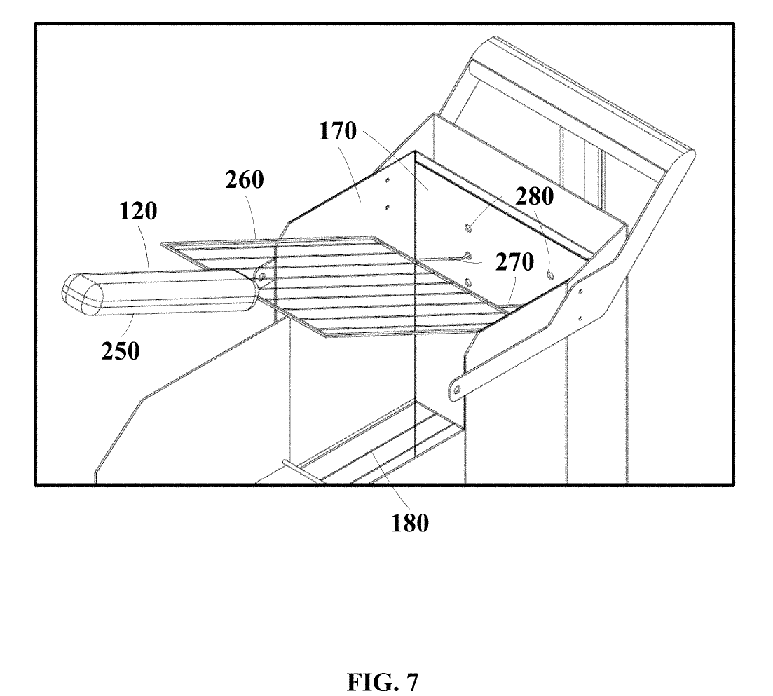

FIG. 7 displays a grill apparatus 5 having a cooking grid 120 affixed to a position above the rock grate 180 in accordance with embodiments. The cooking grid 120 may comprise a grid handle 250, a grid portion 260, and a set of grid protrusions 270 that may be affixed to grid orifices 280 positioned on at least one of the upper chamber sidewalls 170. In embodiments, a plurality of sets of grid orifices 280 may be positioned on at least one upper chamber sidewall 170 so that the cooking grid 120 may be affixed at different distances from charcoal positioned on the rock grate 180.

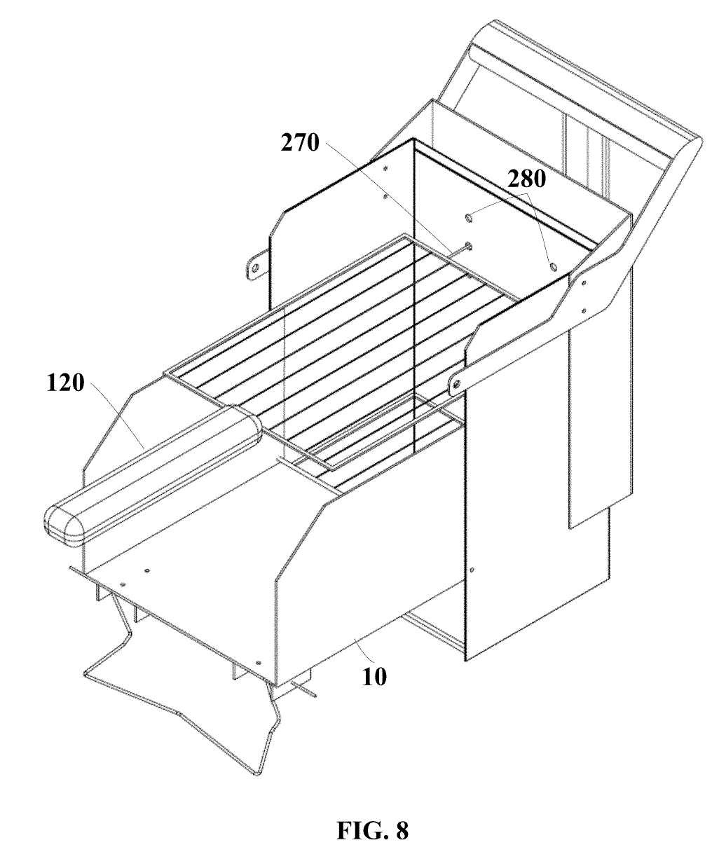

FIG. 8 displays a perspective view of a charcoal grill apparatus 5 including a cooking grid 120 in accordance with embodiments. When the grid protrusions 270 are positioned within a set of grid orifices 280, the cooking grid 120 may be supported and may maintain a position parallel with the open front sidewall 10. The placement of the grid orifices 280 and may allow cooking grid 120 to be positioned at various heights above charcoal found within apparatus 5.

In embodiments, the cooking grid 120 may not include grid protrusions 270. Alternatively, an interior portion of the apparatus 5 may include a cooking grid receiver (not depicted). The cooking grid receiver may include a top elongated portion (not depicted) and a bottom elongated portion (not depicted) that may be separated a distance larger than a thickness of the cooking grid 120. An edge of the cooking grid 120 may slide in between the top elongated portion and the bottom elongated portion. In such an embodiment, the position of the cooking grid 120 may be similar to that shown in FIG. 8.

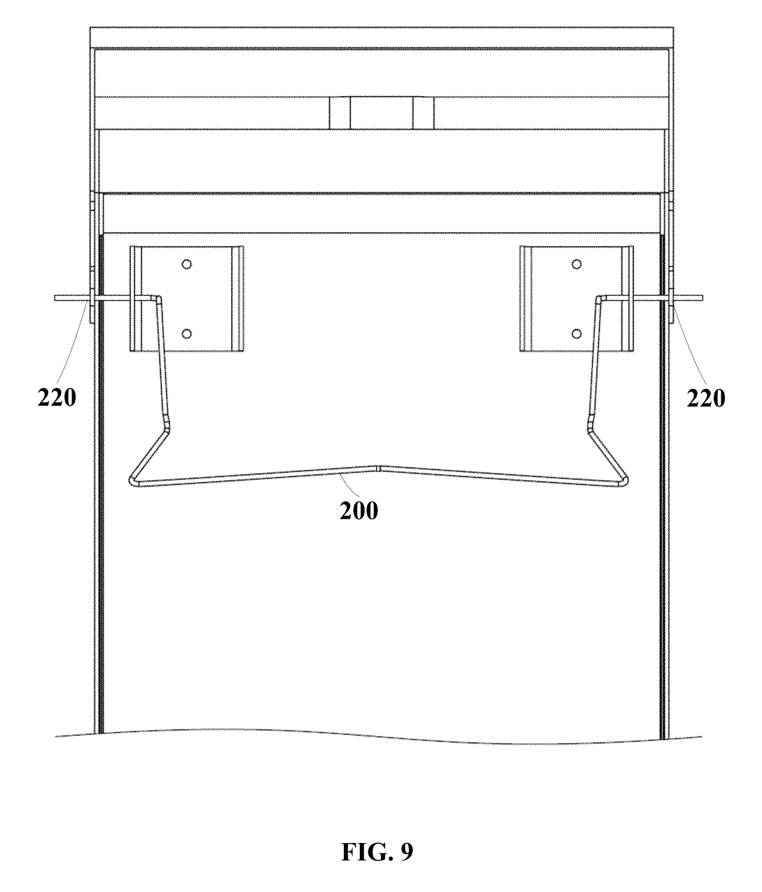

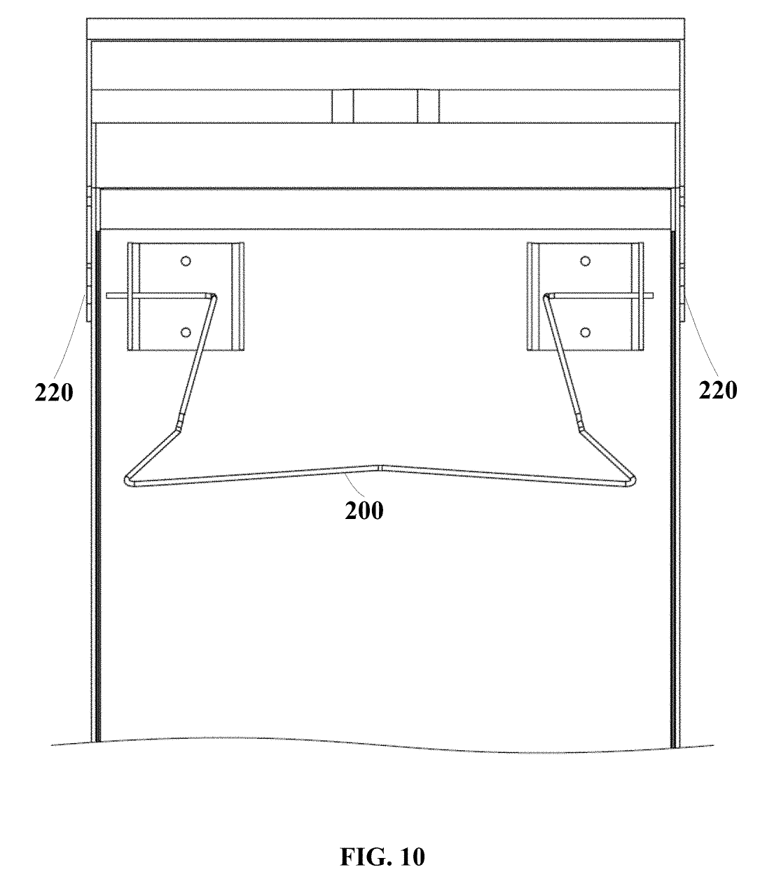

FIG. 9 displays a charcoal grill apparatus 5 having a rest 200 in a first position in accordance with embodiments. The first position of the rest 200 may display portions of the rest 200 within the rest orifices 220. The closer that the rest 200 is to the apparatus 5, the more that the rest 200 may protrude out of the rest orifices 220. When portions of the rest 200 are farther away from apparatus 5, the rest 200 may be pulled farther and farther out of the rest orifices 220. FIG. 10 displays a rest 200 in a second position in accordance with embodiments. The second position of the rest 200 may include portions of the rest 200 not within the rest orifices 220. This may be due to the fact that the rest 200 depicted may be pulled outward from the apparatus 5 in relation to the rest 200 found in FIG. 9.

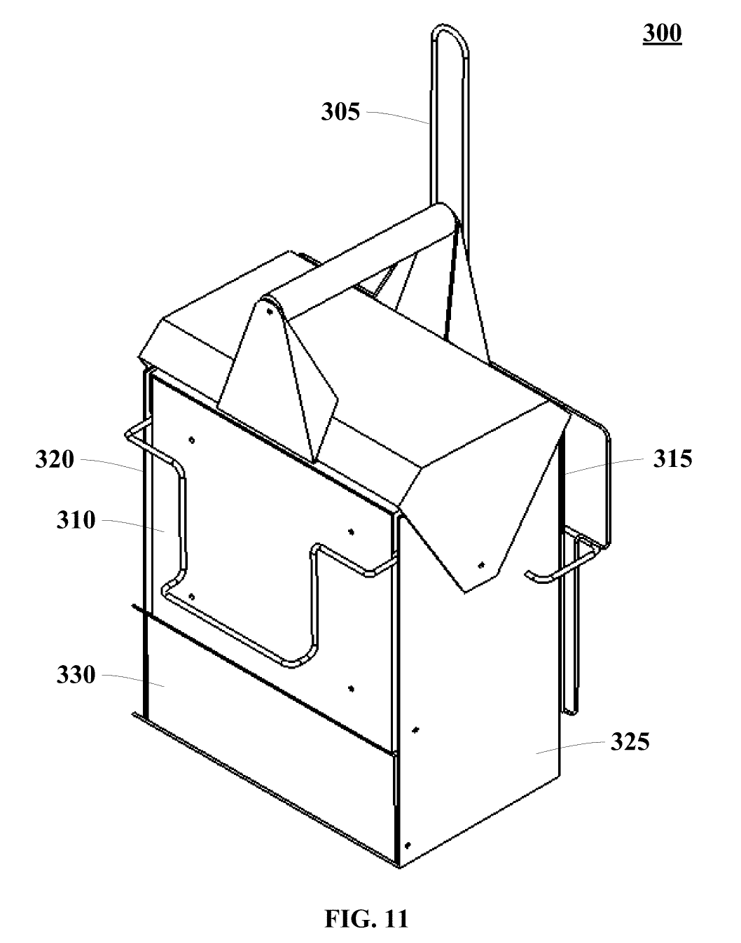

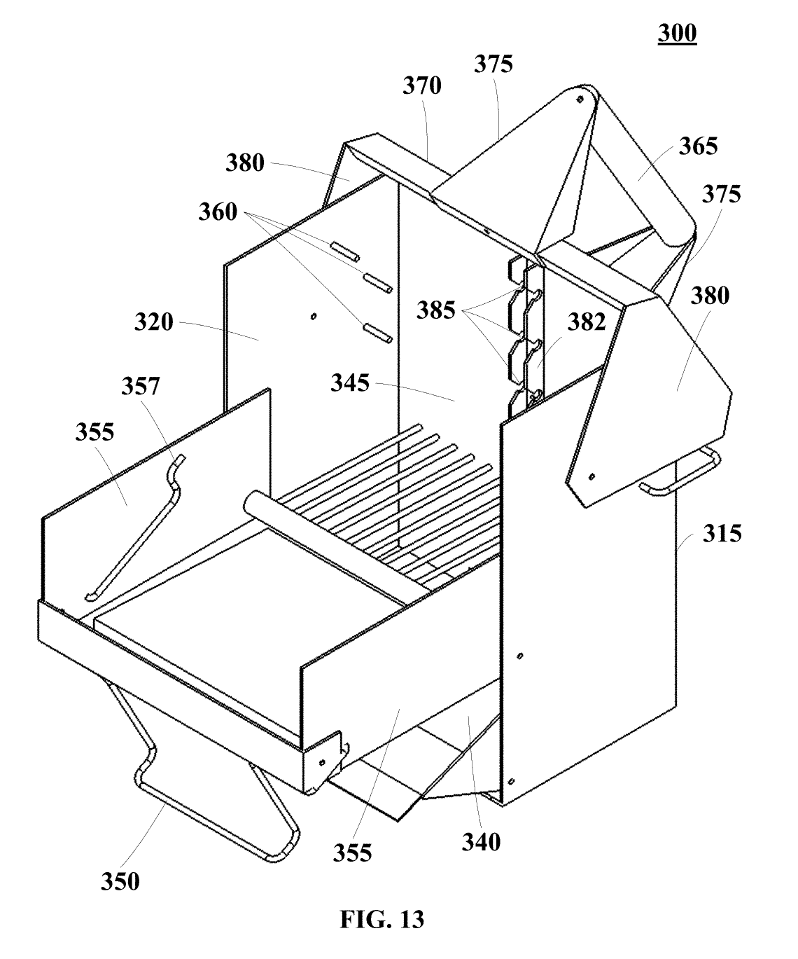

FIG. 11 displays an isometric view of a closed alternative charcoal grill apparatus 300 including a cooking grid 305 in accordance with embodiments. The apparatus 300 may comprise a front sidewall 310, a rear sidewall 315, left sidewall 320, right sidewall 325, and bottom portion (not depicted). A hinged bottom door 330 may be hingedly attached at the bottom edge of the front sidewall 310 and may extend the entire length of the front sidewall 310. A hinged bottom door handle 335 may be positioned along a top edge of the hinged bottom door 330. This may allow for an individual to pull the hinged bottom door 330 outward so that a lower chamber 340 (FIG. 13) may be exposed. Flammable materials (not depicted) may be placed within the lower chamber 340 positioned below the front sidewall 310. In embodiments, the lower chamber 340 may be water-tight and may be able to hold water when water is utilized to extinguish charcoals. When lit, the flammable materials may provide fire and heat to charcoal (not depicted) located in the upper chamber 345 (FIG. 13). The sidewalls 310,315,320,325 may contain the charcoal within the upper chamber 345.

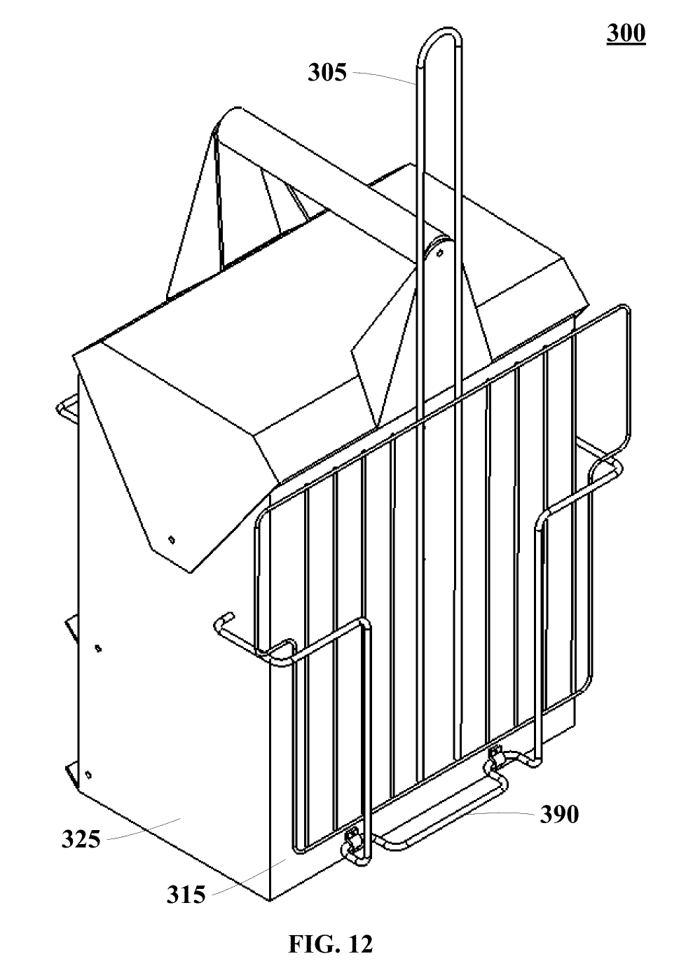

FIG. 12 displays a rear isometric view of a closed alternative charcoal grill apparatus 300 including a cooking grid 305 in accordance with embodiments. A cooking grid 305 may be stored in a cooking grid rack 390 affixed to the left, right, and rear sidewalls 320,325,315. When the cooking grid 305 is not being used, the cooking grid 305 may be stored on the cooking grid rack 390. In embodiments, the cooking grid rack 390 may be affixed to less than the left, right, and rear sidewalls 320,325,315.

A rest 350 may be pivotably affixed to the front sidewall 310. The configuration of the rest 350 may allow for the rest 350 to hinge from a retracted position to an extended position. The rest 350 may penetrate front sidewall interior walls 355 (located on the front sidewall 310) and may extend inside the apparatus 300 as shown in FIG. 13. In embodiments, the rest 350 may terminate at two curved portions 357. FIG. 13 additionally displays a plurality of sets of pegs 360 that may be affixed to the interior surface of the left and right sidewalls 320,325 that may allow for the curved portions 357 of the rest 350 to “catch” on the pegs 360 based on the position of the rest 350. When the curved portions 357 are caught, the front sidewall 310 may not be able to rotate about its hinge. When the curved portions 357 are not caught, the front sidewall 310 may be able to rotate about its hinge. A handle 365 may be affixed to a top panel 370 via top panel extensions 375. The top panel 370 may be affixed to two top side panels 380, which may be hingedly affixed to the left and right sidewalls 320,325. The top panel extensions 375 may be pivotably engageable with portions of the left and right sidewalls 320,325. A cooking grid receiver 382 may vertically extend along an interior portion of the rear sidewall 315 and may include a plurality of receiving ports 385 where the cooking grid 305 may be retained. The placement of the receiving ports 385 may allow cooking grid 305 to be positioned at various heights above charcoal found within apparatus 300.

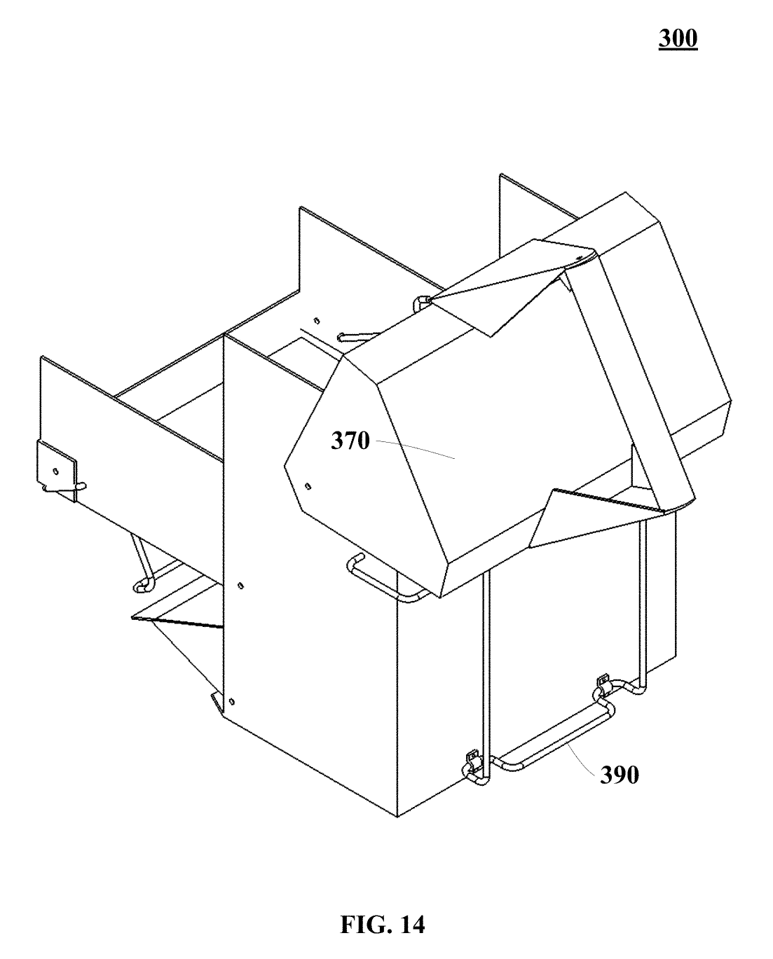

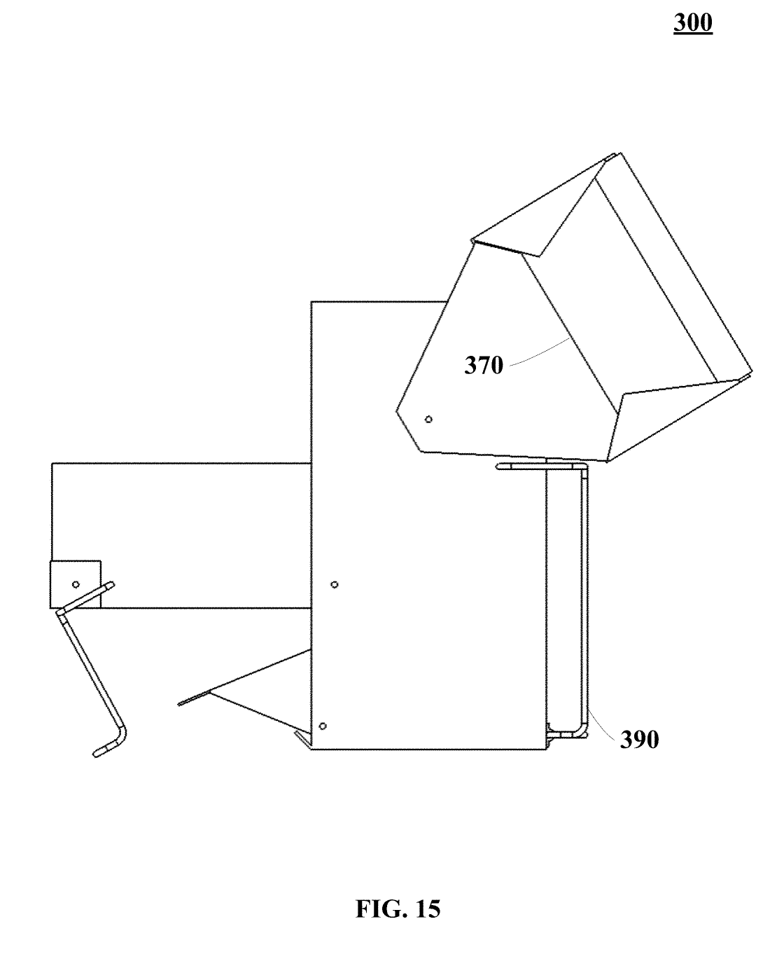

FIG. 14 displays a rear isometric view of an open alternative charcoal grill apparatus 300 without a cooking grid 305 in accordance with embodiments. When the top panel 370 is in an open configuration, the top panel 370 may rest just above the cooking grid rack 390, which may be additionally shown in FIG. 15.

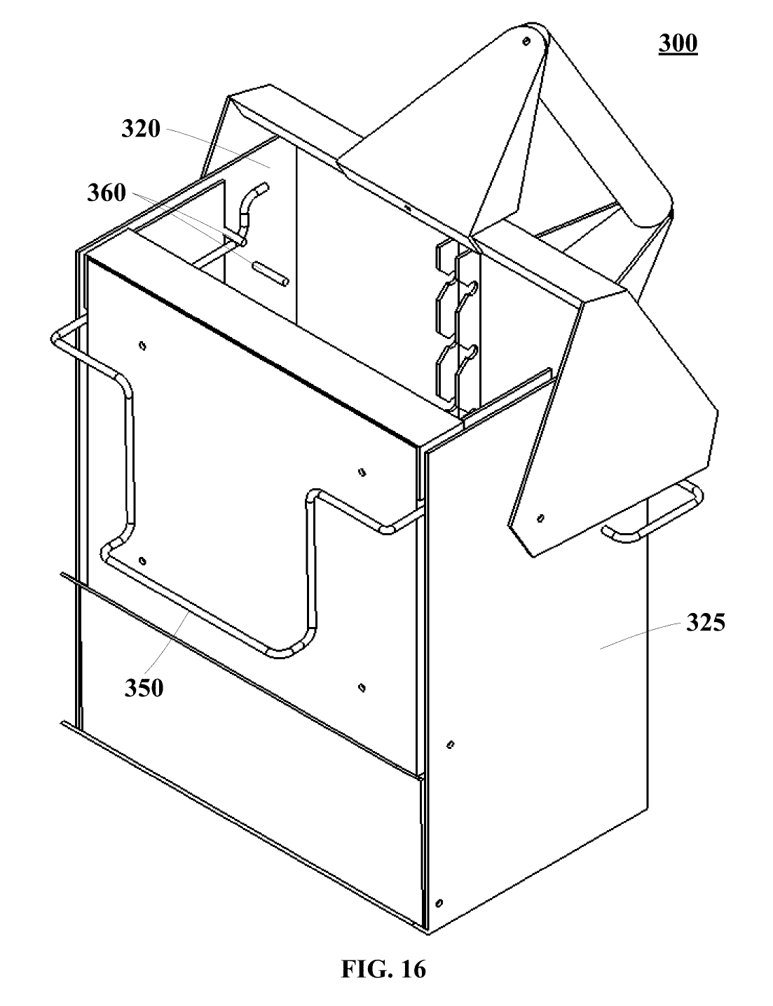

FIG. 16 displays an isometric view of an alternative charcoal grill apparatus 300 with an open top in accordance with embodiments. The curved ends of the rest 350 may engage pegs 360 located on the left and right sidewalls 320,325. Apparatus 300, in this configuration, may be referred to as being in the “chimney configuration.” “Chimney configuration” may refer to the fact that the apparatus 300 may be utilized as a chimney starter in this configuration.

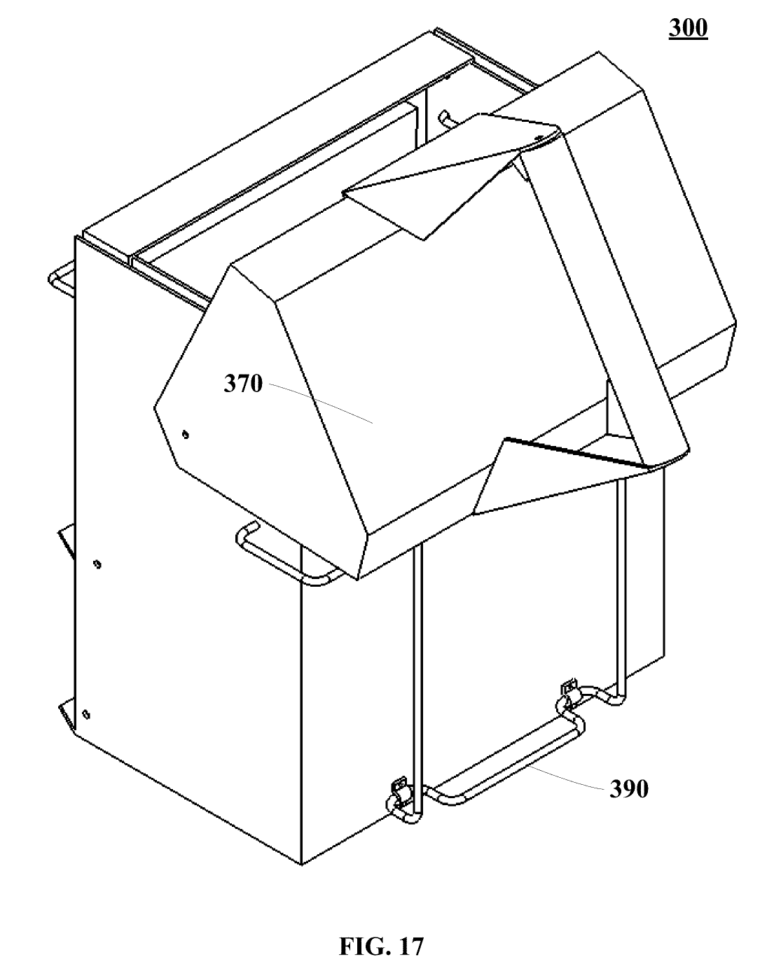

FIG. 17 displays a rear depiction of the apparatus 300 as configured in FIG. 16. The top panel 370 may have room to pivot toward the cooking grid rack 390 when the cooking grid 305 is not stored in the cooking grid rack 390.

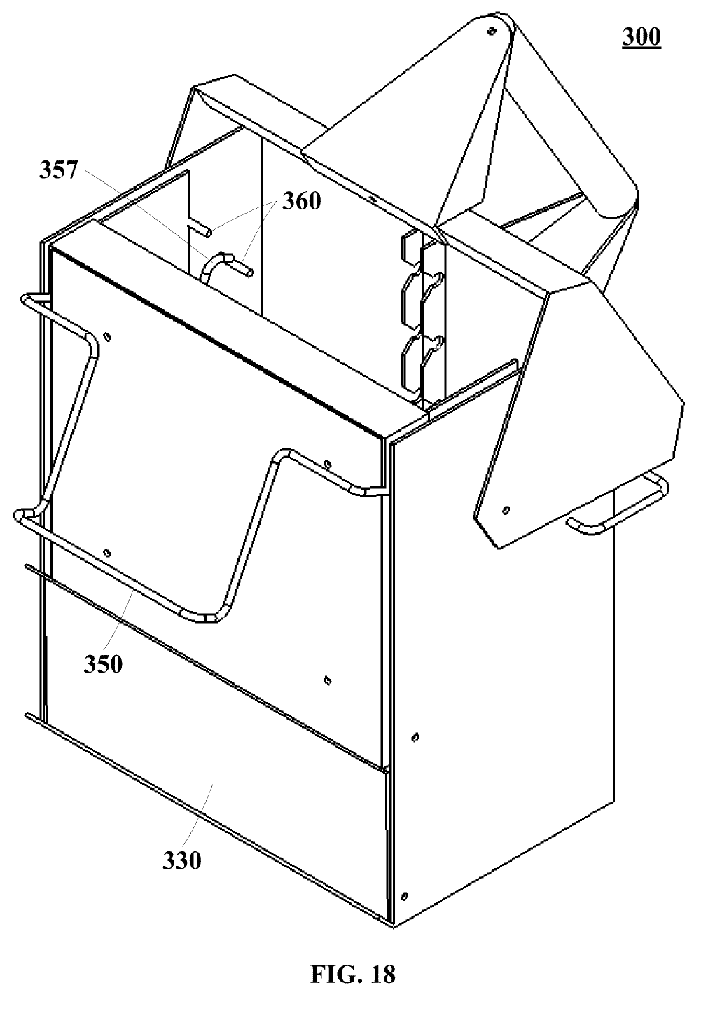

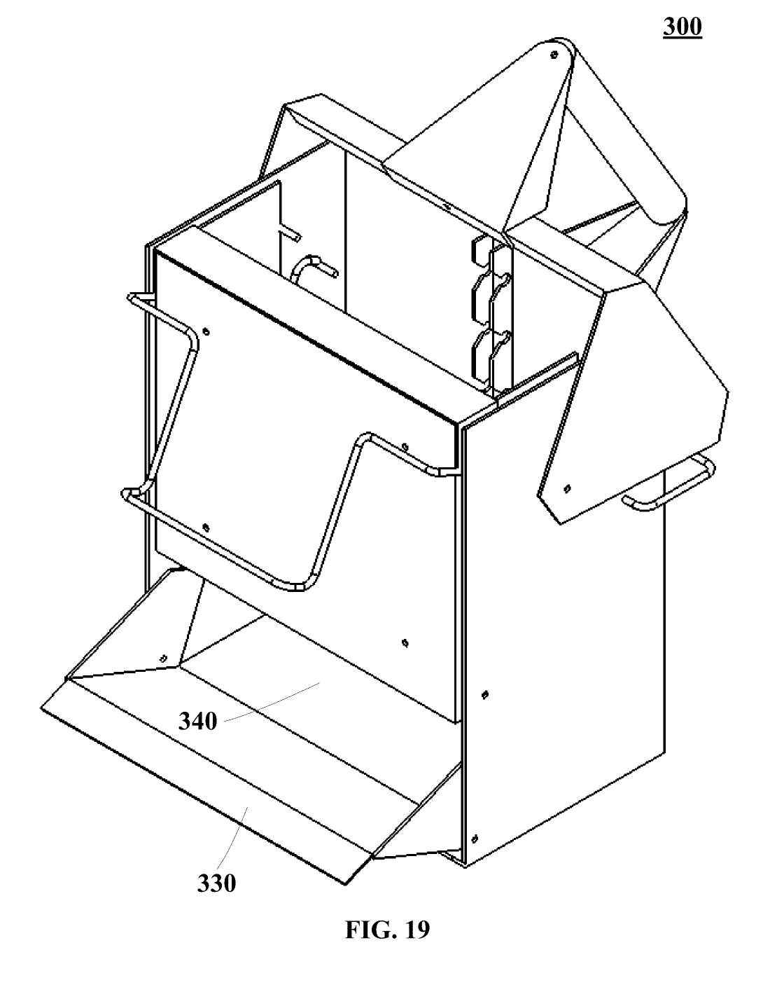

FIG. 18 displays an isometric view of an alternative charcoal grill apparatus 300 with an open top in accordance with embodiments. The rest 350 may be pulled away from the apparatus 300. This may allow for the curved portions 357 to disengage from the pegs 360 (as shown in FIG. 16). FIG. 19 shows the hinged bottom door 330 in an open configuration. The hinged bottom door 330 may rotate about a hinge axis to transition to an open configuration, which may allow exposure of the lower chamber 340.

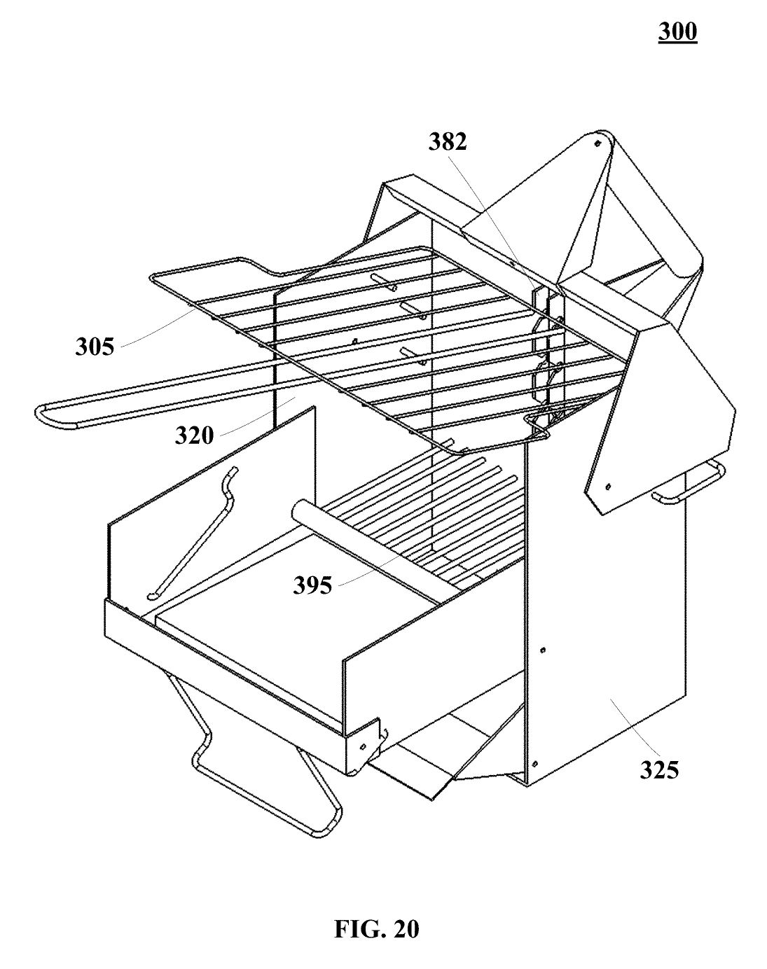

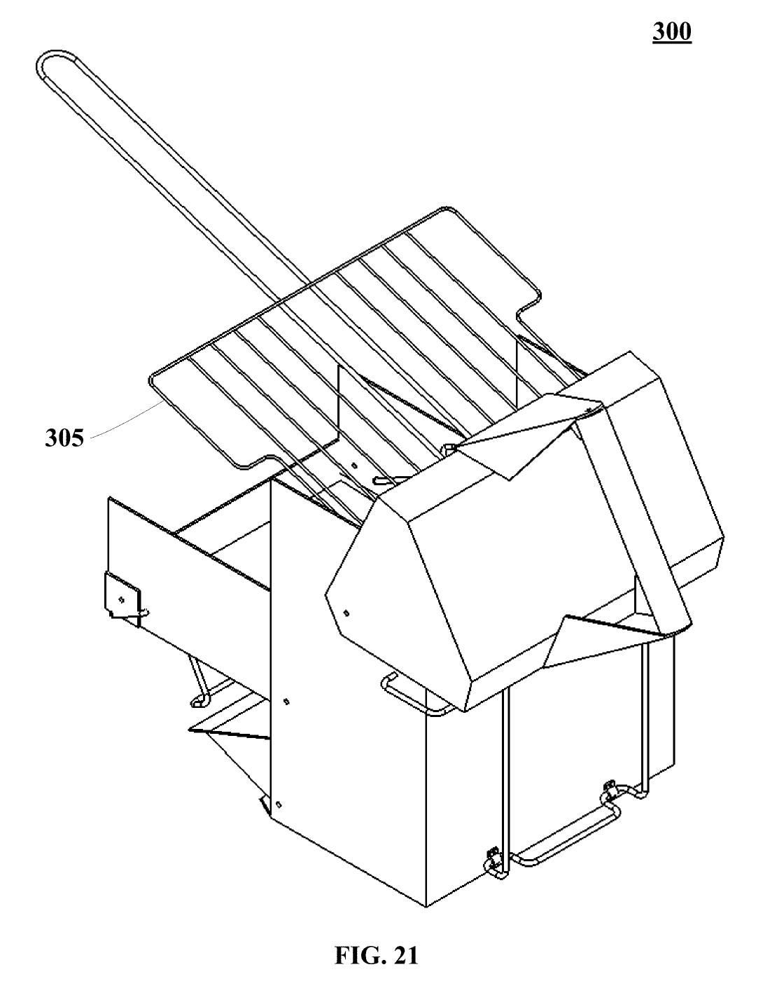

FIG. 20 displays an open isometric view of an alternative charcoal grill apparatus 300 including a cooking grid 305 in accordance with embodiments. The cooking grid 305 is shown in the process of being engaged to the cooking grid receiver 382. The cooking grid 305 may fit between the left and right sidewalls 320,325. Coals may be placed on top of the rock grate 395 and below the cooking grid 305 in order to cook food placed on the cooking grid 305. FIG. 21 displays rear view of the apparatus as depicted in FIG. 20.

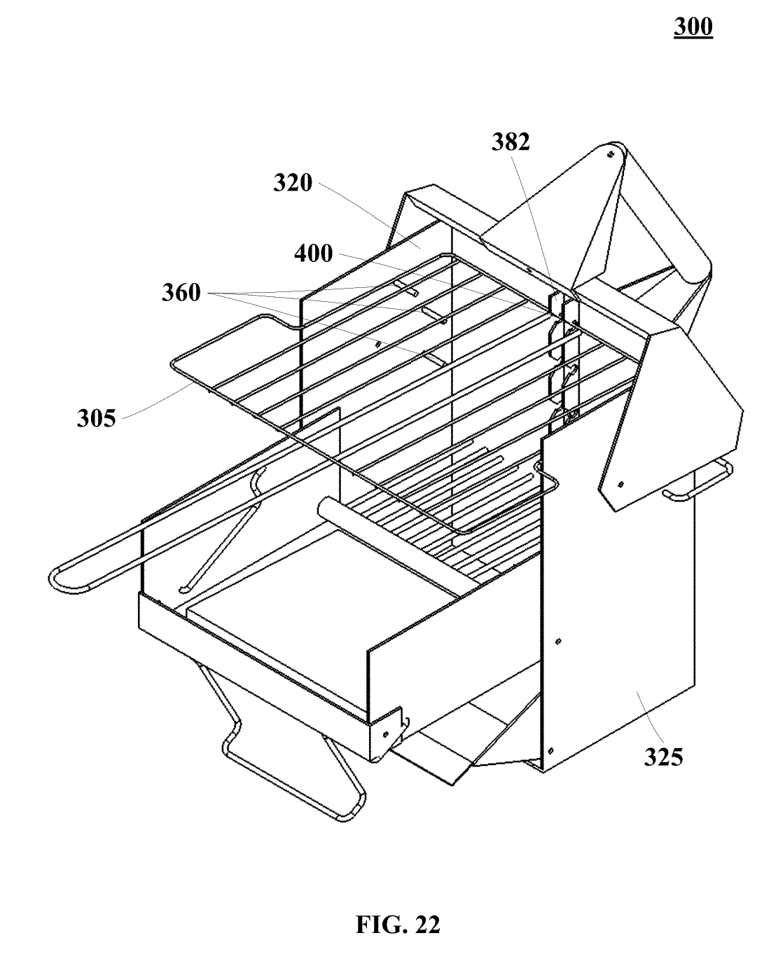

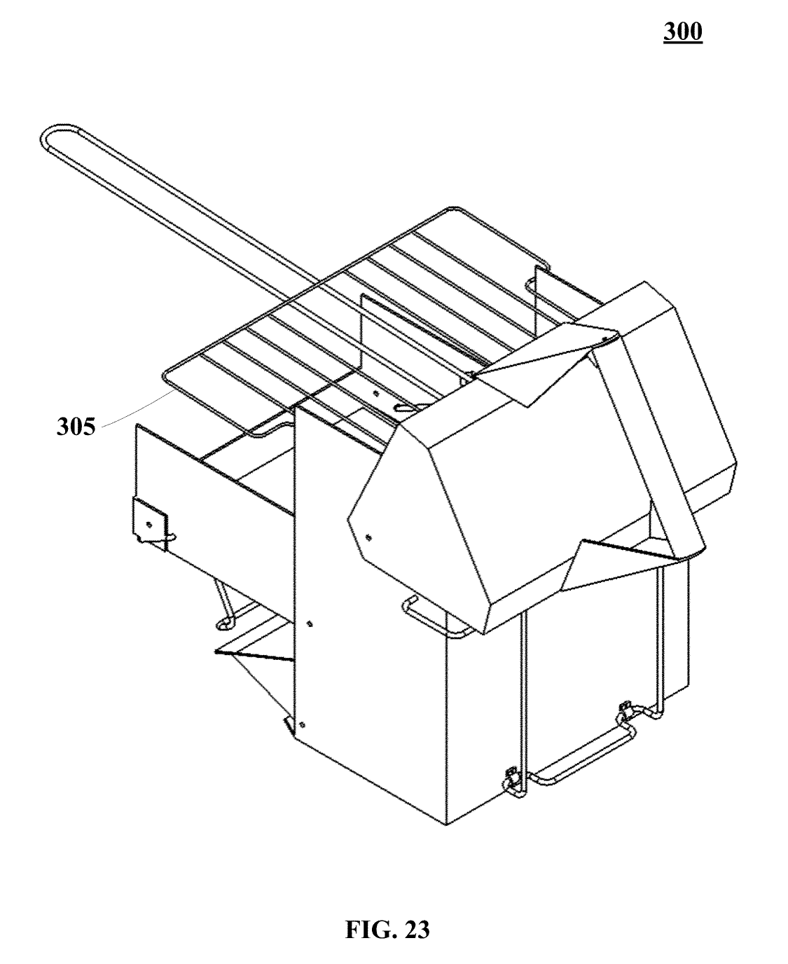

FIG. 22 displays an open isometric view of an alternative charcoal grill apparatus 300 including a cooking grid 305 in accordance with embodiments. The cooking grid 305 may be placed partially within a top receiving port 400 of the cooking grid receiver 382, which may allow for the cooking grid 305 to rest on top of a top set of pegs 360 on the left and right sidewalls 320,325. FIG. 23 displays a rear view of the apparatus as depicted in FIG. 22.

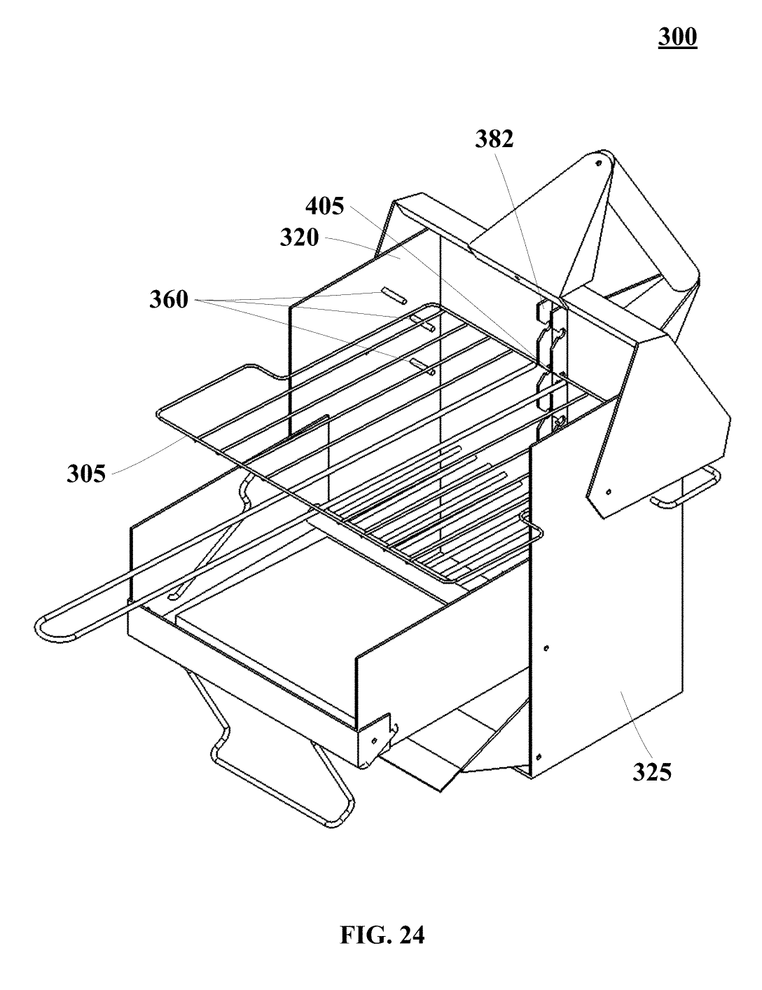

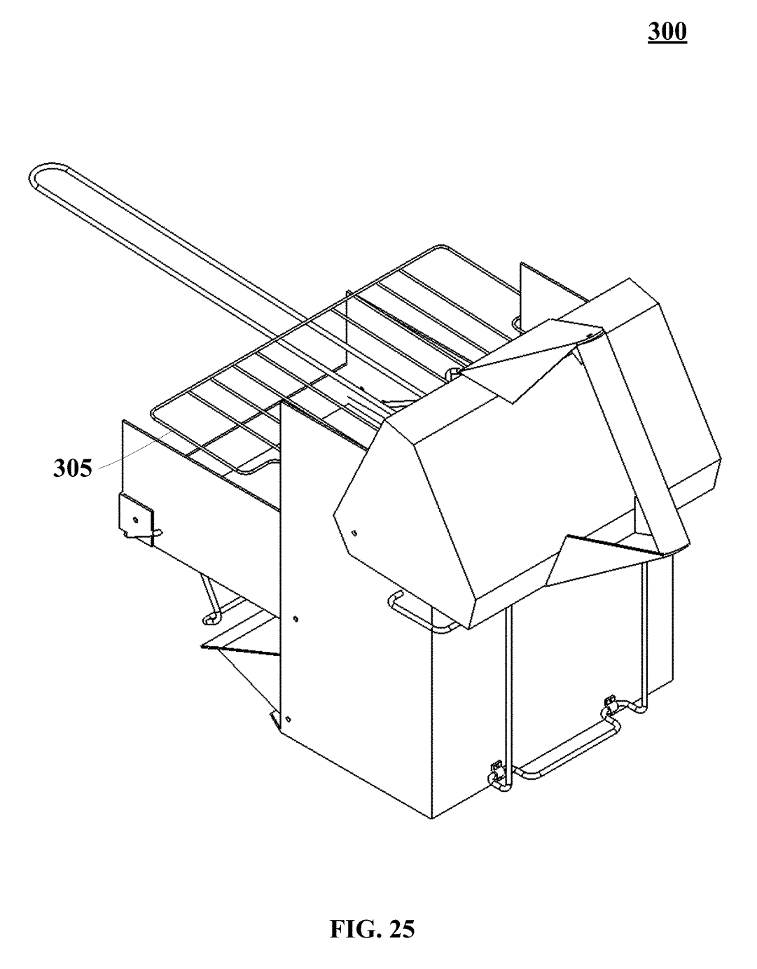

FIG. 24 displays an open isometric view of an alternative charcoal grill apparatus 300 including a cooking grid 305 in accordance with embodiments. The cooking grid 305 may be placed partially within a middle receiving port 405 of the cooking grid receiver 382, which may allow for the cooking grid 305 to be positioned on top of a middle set of pegs 360 on the left and right sidewalls 320,325. FIG. 25 displays rear view of the apparatus as depicted in FIG. 24.

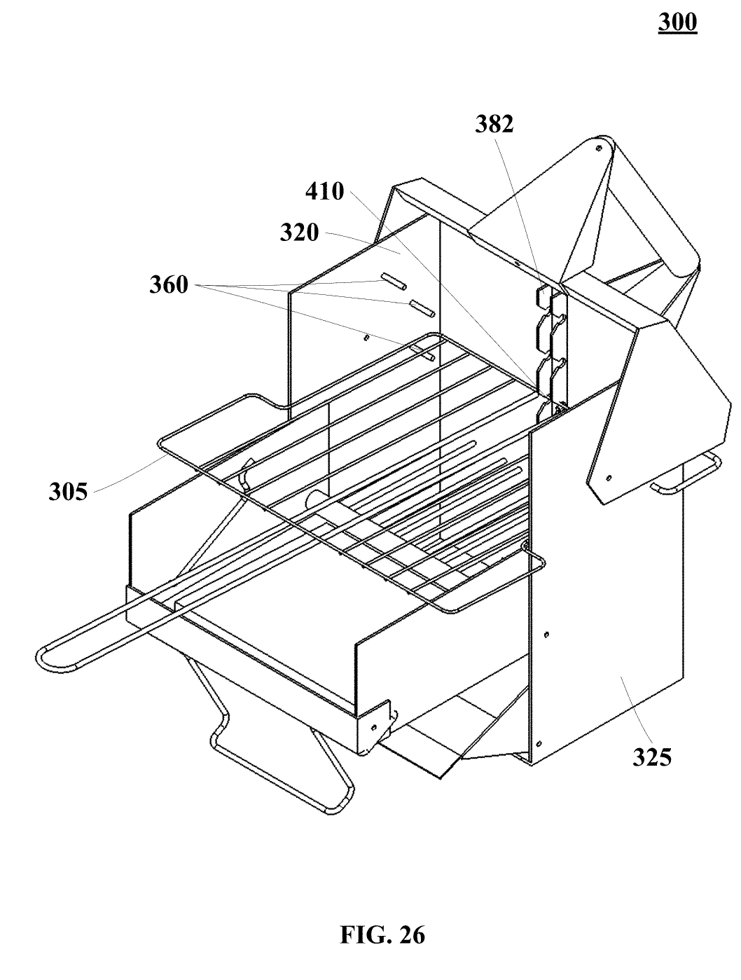

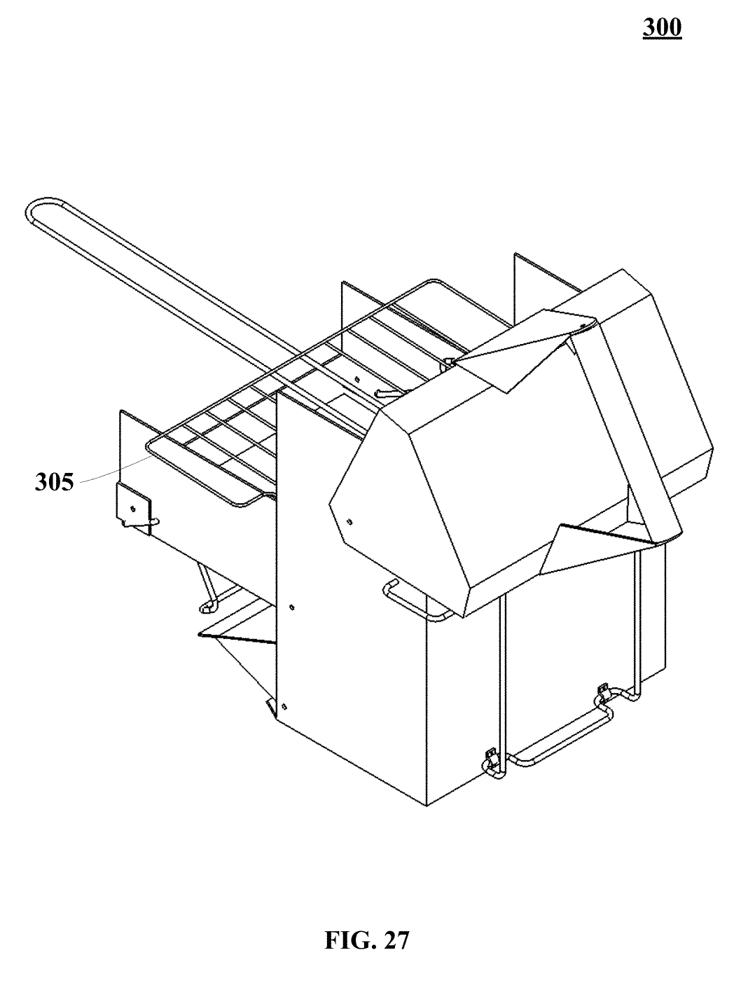

FIG. 26 displays an open isometric view of an alternative charcoal grill apparatus 300 including a cooking grid 305 in accordance with embodiments. The cooking grid 305 may be placed partially within a bottom receiving port 410 of the cooking grid receiver 382, which may allow for the cooking grid 305 to rest on top of a middle set of pegs 360 on the left and right sidewalls 320,325. FIG. 27 displays rear view of the apparatus as depicted in FIG. 26.

In embodiments, the rock grate 180,395 may comprise bars parallel to one another that may be spaced close enough to one another to keep a charcoal from falling through the bars and into the lower chamber 150. The bars may extend from an interior portion of the front sidewall 10,310 to an interior portion of the rear sidewall 20,315.

The disclosed charcoal grill apparatuses 5,300 may function as both a portable chimney starter and a portable grill. In its “chimney configuration”, an individual may fill the apparatus 5,300 with charcoal and ignite kindling material in a lower chamber 150,340 underneath the charcoal. In this embodiment of apparatus 300, the opening of the lower chamber 150 may be adjustable based on the position of the hinged bottom door 330. This assists in inducing the “chimney effect” that may produce a rapid ignition of the charcoal. After the charcoal is lit, an individual may configure the apparatus 5,300 into a “grill configuration” and may operate it as a grill. This may be accomplished by releasing and pulling down the hinged front sidewall 10,310 until it is level with the rock grate 180, revealing additional surface area to spread the charcoal.

A cooking grid 120,305 may then be affixed several inches above the charcoal surface so grilling may commence. This two-in-one utility may eliminate the need for charcoal lighting accessories including chemical accelerants.

In embodiments, to move the two top side panels 380 and the hinged bottom door 330 to an open configuration, the two top side panels 380 and the hinged bottom door 330 may be pivoted in opposite directions. For example, the two top side panels 380 may be pivotable towards the cooking grid rack 390 while the hinged bottom door 330 may be pivotable away from the cooking grid rack 390.

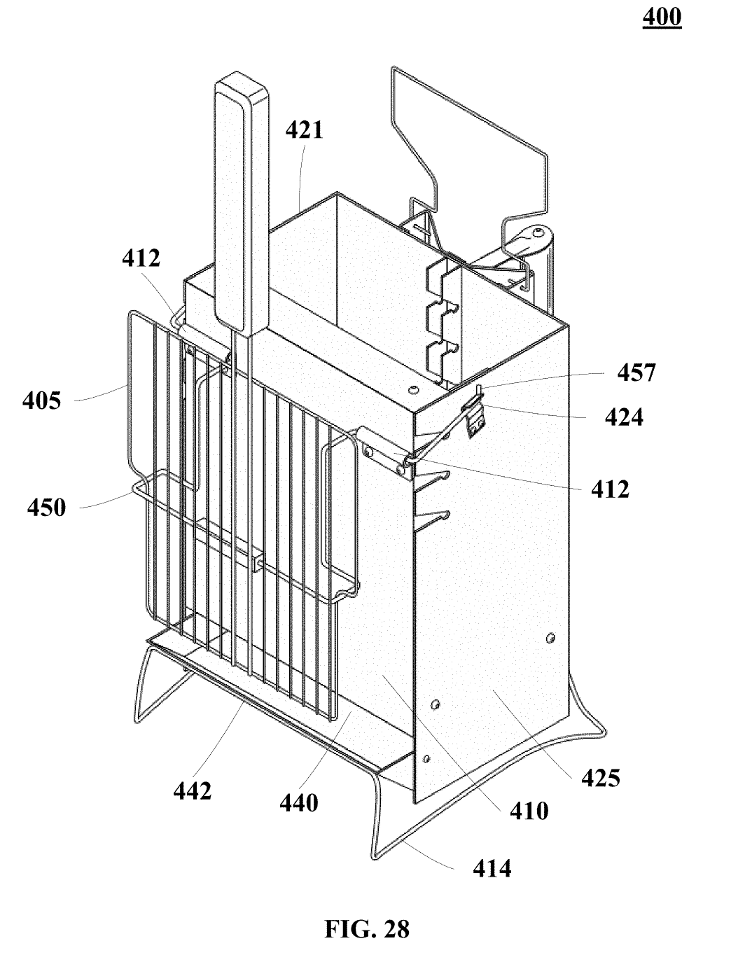

FIG. 28 displays a perspective front view of a charcoal grill apparatus 400 in a “chimney configuration” in accordance with embodiments. “Chimney configuration” may refer to the fact that the apparatus 400 may be utilized as a chimney starter in this configuration. The configuration of apparatus 400 may be similar to the aforementioned apparatuses 5,300 unless otherwise noted. Cooking grid rack 450 may be affixed to the front sidewall 410 via a plurality of retainers 412. Front sidewall 410 may be hingedly affixed to a left sidewall 421 and a right sidewall 425. Cooking grid 405 may be positioned within and may be retained by cooking grid rack 450. Portions of the cooking grid rack 450 may extend along portions of left sidewall 421 and right sidewall 425. A curved end 457 of the cooking grid rack 450 may be retained by cooking grid rack retainers 424 affixed to the left sidewall 421 and the right sidewall 425. This retaining of the curved ends 457 by the cooking grid rack retainers 424 may be illustrative of a latch mechanism.

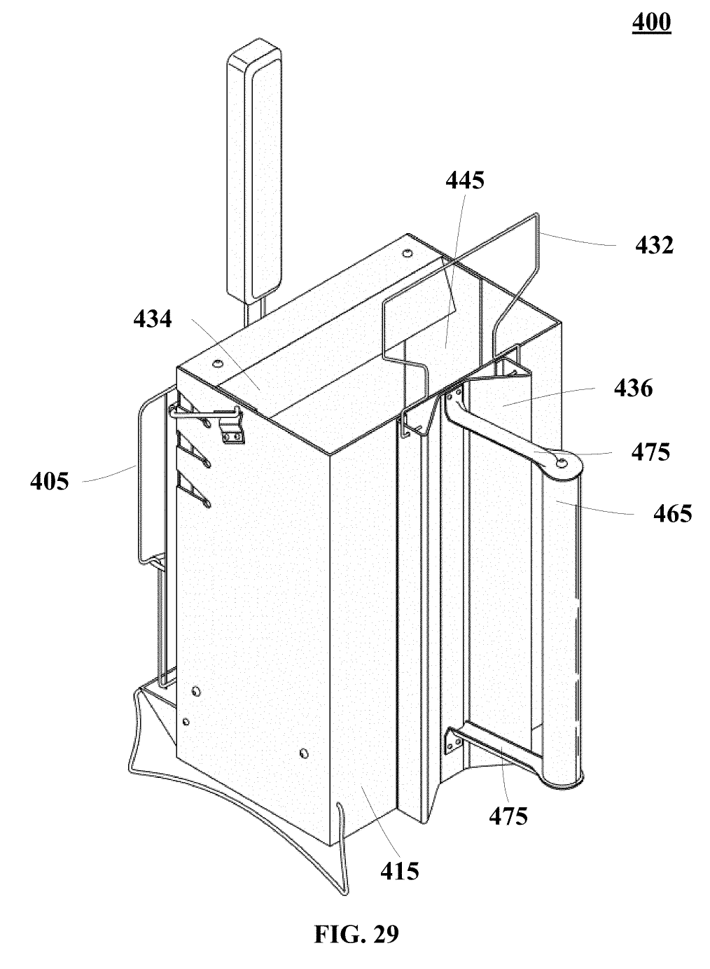

Lower chamber 440 may be positioned within tray 442, which, in embodiments, may be water-tight and may resist leakage when water is utilized to extinguish coals. Tray 442 may be affixed to the left sidewall 421 and the right sidewall 425. Apparatus 400 may rest on a bottom retainer 414 that may comprise at least four corners that may contact a surface. In embodiments, the bottom retainer 414 may be affixed to tray 442 and rear sidewall 415 (see FIG. 29).

FIG. 29 displays a perspective rear view of a charcoal grill apparatus 400 in a “chimney configuration” in accordance with embodiments. The top of the front sidewall 410 may comprise an angled portion 434 contained within an upper chamber 445. A heat shield 436 may be affixed to rear sidewall 415. The heat shield may buffer heat produced inside apparatus 400 to keep the heat from radiating to the handle 465 and the handle extensions 475. In embodiments, the heat shield 436 may extend the entire length of the rear sidewall 415. Handle extensions 475 may be affixed to opposite sides of the heat shield 436. Handle 465 may be positioned between the handle extensions 475. A secondary handle 432 may be hingedly affixed to a top portion of the heat shield 436. In embodiments, portions of the secondary handle 432 may be positioned within orifices found on the heat shield 436.

When utilized as a chimney starter, coals may be positioned within the upper chamber 445 of the apparatus 400. When the coals need to be dumped out of apparatus 400, cooking grid 405 may be removed (if contained within cooking grid rack 450). An individual may then grip handle 465 with one hand and secondary handle 432 with another hand. It is noted that secondary handle 432 may be positioned at an angle in relation to handle 465 when being gripped. Apparatus 400 may then be tipped sideways so that the coals contained within apparatus 400 may exit apparatus 400.

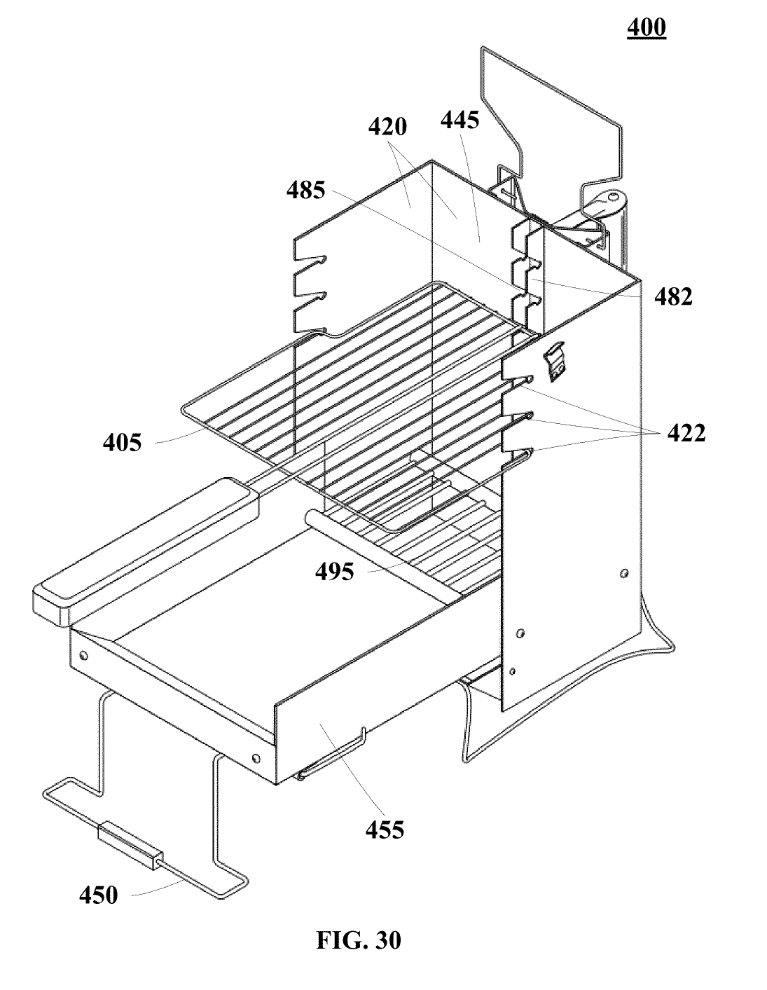

FIG. 30 displays a perspective front view of a charcoal grill apparatus 400 in an “open configuration” in accordance with embodiments. When in an open configuration, front sidewall 410 may rest upon cooking grid rack 450, which may pivot to be in a position parallel to itself when the cooking grid rack 450 is positioned on the apparatus 400 in a chimney configuration. It is noted that cooking grid rack 450 may support the front sidewall 410 when the apparatus 400 is in an open configuration.

Cooking grid 405 may be positioned within upper chamber 445 and may be retained by a pair of a plurality of receiving ports 485 (which are positioned within cooking grid receiver 482) as well as a pair of a plurality of secondary receiving ports 422 positioned on portions of the left sidewall 421 and the right sidewall 425. The placement of the receiving ports 485 and secondary receiving ports 422 may allow cooking grid 405 to be positioned at various heights above charcoal found within apparatus 400.

Flammable materials (not depicted), such as but not limited to, kindling paper, may be placed within lower chamber 440 positioned below rock grate 495. In this embodiment, the opening of the lower chamber 440 may be fixed due to the rigidity of tray 442. When lit, the flammable materials may provide fire and heat to charcoal (not depicted) located in upper chamber 445. Upper chamber sidewalls 420 may contain the charcoal within the upper chamber 445.

In embodiments, front sidewall 410 may comprise a plurality of interior sidewalls 455 that may be positioned within the upper chamber 445 when the apparatus 400 is in the “chimney configuration.”

In embodiments, front sidewall 10,310,410, when in the “open” configuration, may support charcoals that may be heated. These charcoals may help to heat items placed on the cooking grid 120,305,405 when the cooking grid 120,305,405 is positioned above the front sidewall 10,310,410 in the “open” position.

It is noted that, in embodiments, front sidewalls 10,310,410, when in an opened position, may allow for additional space for charcoal.

While this disclosure has been particularly shown and described with reference to preferred embodiments thereof and to the accompanying drawings, it will be understood by those skilled in the art that various changes in form and details may be made therein without departing from the spirit of this disclosure. Therefore, the scope of the disclosure is defined not by the detailed description but by the appended claims.

1. A multipurpose grill apparatus, the apparatus comprising:
a left sidewall;
a right sidewall;
a front sidewall, the front sidewall hingedly affixed to the left sidewall and to the right sidewall, the front sidewall pivotable between a lowered position and an upright position, said front wall lockable in said upright position;
a rear sidewall;
a bottom plate fixedly attached to the left sidewall, the right sidewall, and the rear sidewall, the bottom plate spaced apart from a bottom edge of the front sidewall;
a lower chamber;
an upper chamber positioned above the lower chamber;
a rock grate spaced above the bottom plate, the rock grate separating the lower chamber and the upper chamber;
the front sidewall lowerable into an open position in which the front sidewall is aligned with the rock grate;
a cooking grid receiver affixed to an interior portion of the rear sidewall, the cooking grid receiver comprising a rear receiving port; and
a cooking grid rack affixed to at least one of the front sidewall, the rear sidewall, the left sidewall, and the right sidewall, the cooking grid rack comprising a curved end;
a cooking grid rack retainer affixed to at least one of the left sidewall and the right sidewall, the cooking grid rack retainer configured to disengageably engage the curved end of the cooking grid rack and lock the front sidewall in the upright position.

2. The apparatus of claim 1, further comprising a handle affixed to a plurality of handle extensions, the plurality of handle extensions affixed to at least one of the left sidewall, the right sidewall, and the cooking grid rack.

3. The apparatus of claim 1, further comprising a handle affixed to a plurality of handle extensions, the plurality of handle extensions affixed to a handle retainer affixed to the rear sidewall, and wherein a secondary handle hingedly affixed to the handle retainer.

4. The apparatus of claim 1, wherein the left and right sidewalls each comprise a front receiving port, wherein the front receiving port of the left sidewall is aligned with the front receiving port of the right sidewall, and wherein the front receiving port of each of the left and right sidewalls are recessed into a front edge of their respective sidewalls, and wherein the front receiving ports and the rear receiving port are configured for receiving and suspending a cooking grid in a horizontal position spaced above the rock grate.

5. The apparatus of claim 1, wherein the cooking grid rack is hingedly affixed to the front sidewall.

6. The apparatus of claim 5, wherein the cooking grid rack is further retained by a plurality of cooking grid rack retainers affixed to the left sidewall and the right sidewall when the apparatus is in a chimney configuration.

7. The apparatus of claim 1, further comprising a tray positioned below the front sidewall, the tray affixed to at least one of the right sidewall, and the rear sidewall.

8. The apparatus of claim 7, further comprising a bottom retainer extending from the tray, below the apparatus, to the rear sidewall, and wherein the lower chamber further comprises a top portion extending below the bottom edge of the front sidewall, the lower chamber open to an ambient environment through an aperture, the aperture defined between the bottom edge of the front sidewall and the bottom plate.

9. The apparatus of claim 1, wherein the rear sidewall, left sidewall, and right sidewall formed of a single piece of sheet metal.

10. The apparatus of claim 1, further comprising a handle affixed to a top panel via handle extensions, the top panel hingedly affixed to the left sidewall and the right sidewall via two top side panels.

11. The apparatus of claim 1, further comprising a cooking grid stored in the cooking grid rack.

12. The apparatus of claim 1, further comprising a hinged bottom door enclosing at least a portion of the lower chamber.

13. The apparatus of claim 1, the cooking grid receiver comprising a plurality of receiving ports, wherein the plurality of receiving ports are configured to receive the cooking grid.

14. The apparatus of claim 13, further comprising a plurality of secondary receiving ports positioned on the left sidewall and the right sidewall, the cooking grid resting within at least two of the plurality of secondary receiving ports when the cooking grid is received by one of the plurality of receiving ports.

15. The apparatus of claim 1, wherein the rock grate comprises parallel bars extending from an interior portion of the front sidewall to an interior portion of the rear sidewall, the bars capable of retaining charcoal and keeping the charcoal from falling into the lower chamber.

16. A multipurpose grill apparatus, the apparatus comprising:
a left sidewall;
a right sidewall;
a front sidewall, the front sidewall hingedly affixed to the left sidewall and to the right sidewall;
a rear sidewall;
a bottom plate fixedly attached to the left sidewall, the right sidewall, and the rear sidewall, the bottom plate spaced apart from a bottom edge of the front sidewall;
a lower chamber;
an upper chamber positioned above the lower chamber;
a rock grate spaced above the bottom plate, the rock grate separating the lower chamber and the upper chamber;
a cooking grid receiver affixed to an interior portion of the rear sidewall;
a cooking grid rack affixed to at least one of the front sidewall, the rear sidewall, the left sidewall, and the right sidewall, the cooking grid rack comprising a curved end;
a cooking grid rack retainer affixed to at least one of the left sidewall and the right sidewall, the cooking grid rack retainer configured to disengageably engage the curved end of the cooking grid rack and lock the front sidewall in the upright position;
a handle affixed to a plurality of handle extensions, the plurality of handle extensions affixed to a handle retainer affixed to the rear sidewall;
a secondary handle hingedly affixed to the handle retainer; and
a tray positioned below the front sidewall, the tray affixed to at least one of the left sidewall, the right sidewall, and the rear sidewall.

17. The apparatus of claim 16, wherein the cooking grid rack is hingedly affixed to the front sidewall.

18. The apparatus of claim 17, wherein the cooking grid rack is further retained by a plurality of cooking grid rack retainers affixed to the left sidewall and the right sidewall when the apparatus is in a chimney configuration.

19. The apparatus of claim 16, further comprising a bottom retainer extending from the tray, below the apparatus, to the rear sidewall.

20. The apparatus of claim 16, wherein the tray is water-tight.
